(19) United States
(12) Patent Application Publication
(10) Pub. No.: US 2024/0405855 A1
(43) Pub. Date: Dec. 5, 2024

(54) DISTRIBUTED ADDRESSING AND FAST ROUTING METHOD AND SYSTEM THEREOF

(71) Applicant: Beijing Jiaotong University, Beijing (CN)

(72) Inventors: Wei QUAN, Beijing (CN); Mingyuan LIU, Beijing (CN); Hongke ZHANG, Beijing (CN); Ziheng XU, Beijing (CN); Xue ZHANG, Beijing (CN); Yan LUO, Beijing (CN); Jun DENG, Beijing (CN); Tong LUO, Beijing (CN); Jiaqi LI, Beijing (CN)

(21) Appl. No.: 18/672,954

(22) Filed: May 23, 2024

(30) Foreign Application Priority Data
May 23, 2023 (CN) 202310585122.0

(51) Int. Cl. H04B 7/185; H04L 45/745

(52) U.S. Cl. CPC H04B 7/18519; H04L 45/745

(57) ABSTRACT

Provided is a distributed addressing and fast routing method and a system thereof, which belongs to the technical field of satellite communication. First, a satellite relative motion model is established, thereafter, an appropriate reference frame satellite is selected to deploy a controller based on the established satellite relative motion model, subsequently, satellite addresses have been allocated based on the deployed controller, and finally a routing table is synchronously established based on the allocated satellite addresses. A brand-new packet communication protocol of the present disclosure is more flexible in setting the structure of each field. Positioning the controller satellite with betweenness centrality ensures the short-distance communication between the controller and the satellites. The distributed addressing method reduces the frequent communication between satellites and improves the address allocation speed.

### CROSS-REFERENCE TO RELATED APPLICATION

This patent application claims the benefit and priority of Chinese Patent Application No. 202310585122.0 filed with the China National Intellectual Property Administration on May 23, 2023, the disclosure of which is incorporated by reference herein in its entirety as part of the present application.

### TECHNICAL FIELD

The present disclosure relates to the technical field of satellite communication, in particular to a distributed addressing and fast routing method and a system thereof.

### BACKGROUND

With the continuous development of satellite technology, the mode of using satellite Internet as ground support network has attracted more and more attention. The satellite Internet is extensive in signal coverage, high in communication frequency and rich in frequency bands, and plays an important role in civil, military, traditional and new networks. According to prediction from Gartner in 2021, low-orbit satellites will cover the region where one billion of the poorest people in the world live in 2027, thereby helping 50% of them get rid of poverty. The remarkable feature that the coverage of the satellite Internet is extensive has solved the signal coverage problem of the modern terrestrial communication network and has become an indispensable part of supporting terrestrial network communication.

Under this development trend, the satellite Internet has been widely researched. Especially the satellite control ability is facing new requirements, and the control function in the satellite Internet is facing new challenges along with the integration of the software defined networking (SDN) architecture and the satellite network and the rapid development of the satellite-terrestrial integrated communication architecture. At present, researches on satellite network control can be divided into three aspects according to the research points.
(1) A deployment of the satellite network controller. Such researches focus on the deployment position of the controller. A good deployment position can shorten the distance between the controller and the satellite and improve the efficiency of sending control instructions. These researches mainly aim at selecting the optimal controller position through graph theory analysis, topology and load prediction, experimental test and other methods after modeling the number and the position of controllers.
(2) An allocation of the satellite network resource. Such researches focus on optimizing the resource allocation of each satellite and improving the data transmission performance by using the control network. These researches include analyzing mission time and waiting time of satellites, and discussing task placement algorithm to improve efficiency of processing tasks of satellite. Such researches also include sensing the network state, dynamically and efficiently distributing content to precise positions, and improving video service experience of a user.
(3) An addressing and routing of the satellite network. In such researches, various addressing methods are discussed based on a terrestrial communication network according to the SDN architecture and the network topology. According to the hierarchical architecture of the computer network, such researches analyze addressing and routing from aspects of topology exploration in layer 2, address allocation in layer 3, and communication connection establishment in layer 4. Other researches focus on the problem of rapid recovery after path failure, to realize stable network transmission.

There are essential differences between the satellite network and the terrestrial communication network in terms of topological structure and communication mode. As the satellite orbits the earth periodically and at high speed, its topological structure changes greatly, so that it is difficult to directly apply node addressing and routing method of the terrestrial communication network. Communication is carried out between satellites through wireless signals, and communication distance and topological connection stability of adjacent satellites are lower than those of the terrestrial communication network. In addition, due to its hardware constraints, the satellite is extremely limited in network resources, and most of the network resources need to provide support to the terrestrial communication network. Therefore, the satellite network has a higher demand for addressing and routing, and faster address allocation and routing forwarding speed are needed because of rapid topology change of the satellite network, to ensure the completion of network-wide configuration and packet transmission before topology change. Its own limited resources require low resource occupation of the control network to ensure effective support for the terrestrial communication network.

For satellite addressing and routing, in a routing method for addressing at a network layer based on space position information and a routing device therefor proposed by Tsinghua University, when receiving a packet, the satellite determines the position direction of a next-hop satellite according to its own space position information and a space position information of a destination satellite, and determines a packet forwarding port according to this position direction and a relative orientation of its own space position, and forwards packets to this port.

In conclusion, the existing satellite addressing and routing methods have shortcomings of insufficient utilization of satellite communication relationship, absence of global vision and requirement of additional delay for calculating forwarding direction. Firstly, using the ground as a reference frame of the satellite space position, only communication connection between the satellite and its neighbors is concerned, and communication situation of the satellite network is not taken into account as a whole, so that it is impossible to ensure the transmission performance of the shortest forwarding path in data transmission. Secondly, the satellite only starts to calculate the forwarding direction after receiving the packet, and the calculation time cannot be avoided, which may even lead to a result of disconnection of communication with neighboring satellites after the calculation.

### SUMMARY

The purpose of the present disclosure is to provide a distributed addressing and fast routing method and a system thereof to solve at least one technical problem in the above background. A distributed addressing and fast routing mechanism is proposed. In this mechanism, each satellite can independently complete networking and address configuration of a satellite network, and simultaneously generate a plurality of routes during a networking process. These routes can support fast table lookup and forwarding of communication signals and realize fast data transmission. The mechanism only occupies a small amount of satellite resources, its distributed address configuration speed is higher than that of centralized address allocation mechanism, its routing table is simple, its query speed is shorter than that of other methods, and its routing table contains rich backup paths, which can ensure an uninterrupted transmission of communication signals after link failure.

In order to achieve the above purpose, the present disclosure provides the following technical scheme.

On the one hand, the present disclosure provides a distributed addressing and fast routing method, including:
allocating an orbit number to an orbit, allocating a satellite number to a satellite in the orbit, mirroring the orbit of the satellite, forming an equivalent matrix satellite topology, and establishing a satellite relative motion model;
selecting a reference frame satellite to deploy a controller based on an established satellite relative motion model, so that communication time between the controller and a farthest satellite is shortest upon allocating a satellite address;
broadcasting an address allocation packet based on the controller deployed; receiving, by the satellite, the address allocation packet broadcasted and confirming an address of the satellite itself, and broadcasting, by the satellite, the address allocation packet to complete a satellite address allocation;
synchronously establishing a routing table after confirming the address of the satellite itself and neighbor information based on an allocated satellite address.

In an embodiment, the allocating an orbit number includes: describing each orbit through a set O, where n is a total number of orbits in a low earth orbit satellite network; and sequentially numbering the orbits from a certain orbit;

O={O₁, O₂, O₃, . . . , Oₙ}.

In an embodiment, the mirroring the orbit of the satellite includes: splitting the orbit of the satellite in an annular shape with an orbital intersection point as a split point; mirroring two split satellite orbits by the split point, so that the satellite orbits are in a same range; stretching mirrored orbits such that each orbit is stretched into a straight line, thereby forming a planar satellite motion topology.

In an embodiment, the forming an equivalent matrix satellite topology includes: adjusting the planar satellite motion topology by using a satellite communication ability between adjacent orbits, and placing communicationable satellites in different orbits at a same horizontal position to form a satellite topology in matrix form.

In an embodiment, determining the relative motion model finally by the equivalent matrix satellite topology, includes: by selecting a moving satellite as a reference frame, establishing the relative motion model with a relative position as satellite coordinates, a reference frame satellite as an origin, an orbit change direction of the reference frame satellite as x axis and an orbit of the reference frame satellite as y axis, and with motion position of each satellite expressed in form of coordinates.

In an embodiment, selecting a satellite where betweenness center point is located as the reference frame satellite, and by means of a concept of betweenness centrality, obtaining a betweenness of a satellite node as a number of shortest paths passing through the satellite node in the network, and betweenness centrality of the satellite node as a sum of ratios of the number of shortest paths between any two points passing through the satellite node to a number of all shortest paths:

$$g ( v ) = {\sum }_{s \neq v \neq t} \frac{{σ}_{s t} ( v )}{{σ}_{s t}}$$

where σₛₜ is a total number of shortest paths from node s to node t, σₛₜ(v) is a number of paths passing through node v; a node with a largest betweenness centrality value is selected as the origin of the reference frame by comparing the betweenness centrality of each node, and the controller is deployed to realize the shortest path, that is, a betweenness center point v has a largest betweenness centrality, has a most number of shortest paths passing through the node, and paths from both ends of these shortest paths to a node v, i.e., the betweenness center point v, are also shortest paths, and the node v reaches a most other nodes in a shortest distance.

In an embodiment, the address allocation packet in terms of structure includes layer 2 and layer 3 protocols of the network; where the layer 2 protocol is a standard Ethernet protocol, source/destination physical addresses are both satellite physical addresses in packet transmission; and the layer 3 protocol contains an address confirmation packet and an address update packet.

In an embodiment, both the address confirmation packet and the address update packet have a same source address length field and a same source address field; the address confirmation packet has a destination address field indicating a satellite address of a packet receiving end, and a receiving satellite confirms its own address according to the destination address field; the destination address field in the address update packet is variable in length, which stores an address space that the receiving satellite uses as an address of the receiving satellite itself.

In an embodiment, the broadcasting an address allocation packet based on the controller deployed; receiving, by the satellite, the address allocation packet broadcasted and confirming an address of the satellite itself, and broadcasting, by the satellite, the address allocation packet to complete a satellite address allocation, includes:
upon receiving the address confirmation packet, determining, by the satellite, whether the address confirmation packet is valid, where a determination criteria of validity is whether a port has received the address confirmation packet; if the address confirmation packet is invalid, the address confirmation packet is directly discarded; if the address confirmation packet is valid, the address confirmation packet is a first address confirmation packet received by the port;
according to the first address confirmation packet received, determining the address of the satellite itself (that is, each satellite determines its own address), storing a source address as a sending satellite address, and recording neighbor information of the satellite itself;
broadcasting, by the satellite, the address update packet to a port that has not been invalidated according to the address of the satellite itself and the neighbor information obtained;
broadcasting, by the satellite, the update packet through the port to update an available address space of surrounding satellites.

In an embodiment, wherein after the satellite receives the address update packet, a validity of the address update packet received is determined, the validity is determined by whether the address confirmation packet has been received; if the satellite has received the address confirmation packet, the satellite has completed address allocation, and newly received address update packet is directly discarded; conversely, if the address update packet is valid, the satellite extracts a plurality of available satellite addresses contained in destination addresses of the address update packet and stores the available satellite addresses in a temporary register.

In an embodiment, when the satellite receives a second address update packet, if the second address update packet is from a same source as a first address update packet, extracting, by the satellite, a destination address content of a new packet and updating an available satellite address space in the temporary register; if the second address update packet comes from a new satellite, extracting, by the satellite, the destination address content of the second address update packet, and comparing a new address space with an old address space in the temporary register, and selecting an overlapping address as the address of the satellite itself.

In an embodiment, the comparing a new address space with an old address space in the temporary register includes: assuming that the old address space includes a set ADDR₁ and the new address space includes a set ADDR₂, selecting, by the satellite, an address addr_{final} of the satellite itself by comparing same elements in two sets, as shown in following equation:

$${addr}_{final} = \{ addr \vert addr ∈ {ADDR}_{1} , a d dr ∈ {ADDR}_{2} \} .$$

In an embodiment, in process of the address allocation, the addr calculated by each satellite is unique; after confirming the address of the satellite itself, the satellite (e.g., satellite A) needs to store the neighbor information and reply the address confirmation packet to a source satellite (e.g., satellite B) that has sent the address update packet to inform the source satellite (i.e., the satellite B) of an satellite address of the satellite itself (i.e., the satellite address of the satellite A).

In an embodiment, the broadcasting, by the satellite, the address update packet to a port that has not been invalidated includes: using the address of the satellite itself as the source address, adding one to address coordinate of the satellite itself and subtracting one from the address coordinates of the satellite itself to form four addresses as the destination addresses, and removing a confirmed neighbor address from the destination addresses.

In an embodiment, the synchronously establishing a routing table after confirming the address of the satellite itself and neighbor information based on an allocated satellite address includes: matching the routing table by using address coordinate magnitude, where header of the routing table includes condition 1 and condition 2 corresponding to a matching condition of the address coordinate magnitude, a next-hop address corresponding to next-hop forwarding satellite information of the packet, an exit port corresponding to a forwarding direction of the packet, and a priority indicating a priority order of each port when there are a plurality of exit ports.

In an embodiment, the routing table of a satellite with coordinate (u,v) contains four possible table lookup matching conditions corresponding to four different directions of the destination address for the satellite with coordinate (u,v); when one of the table lookup conditions is satisfied, the satellite with coordinate (u,v) preferentially selects a vertical direction to forward the packet; where the exit port corresponding to the next-hop address is filled in when neighbor satellite information is acquired.

In an embodiment, the priority ensuring adjustment and backup of satellite forwarding path, includes: changing, by the satellite, a packet forwarding direction by adjusting priority value; when a link fails, selecting, by the satellite, a backup path according to the priority value to prevent a control information packet from failing to reach a destination satellite.

In a second aspect, the present disclosure provides a system of distributed addressing and fast routing based on the method described above, including:
an establishing module, configured to allocate an orbit number to an orbit, allocate a satellite number to a satellite in an orbit, mirror the orbit of the satellite, form an equivalent matrix satellite topology, and establish a satellite relative motion model;
a deploying module, configured to select an appropriate reference frame satellite to deploy a controller based on an established satellite relative motion model, so that communication time between the controller and a farthest satellite is the shortest upon allocating a satellite address;
an allocating module, configured to complete a satellite address allocation based on a deployed controller;
a synchronizing module, configured to synchronously establish a routing table after confirming an address of a satellite itself and neighbor information based on an allocated satellite address.

In a third aspect, the present disclosure provides a device for distributed addressing and fast routing, including the system of distributed addressing and fast routing as described above.

In a fourth aspect, the present disclosure provides a non-transient computer-readable storage medium, in which computer instructions are stored. The computer instructions, when executed by a processor, implement the distributed addressing and fast routing method as described above.

In a fifth aspect, the present disclosure provides a computer program product including a computer program, where the computer program, when operating on one or more processors, implements the distributed addressing and fast routing method as described above.

In a sixth aspect, the present disclosure provides an electronic device including a processor, a memory and a computer program, where the processor is connected with the memory, the computer program is stored in the memory, and when the electronic device operates, the processor executes the computer program stored in the memory, so that the electronic device executes instructions for implementing the distributed addressing and fast routing method as described above.

### Technical Terms

Satellite control network is a proprietary network for transmitting control signals between satellites. A transmission entity is the same as a satellite data transmission network, but is logically separated. After a completion of deployment of satellite device, it is necessary to complete an establishment of the satellite control network as soon as possible to lay a solid foundation for satellite data network transmission and provide guarantee for terrestrial communication.

Polar orbiting satellite is a low earth orbit satellite whose orbit passes through polar region. Polar orbiting satellites are often used for terrestrial communication support and long-distance information transmission. As flight path of such satellite passes through the polar region, its communication coverage area can be spread all over the ground, thereby ensuring the stable and uninterrupted terrestrial communication service and information transmission.

Distributed addressing and fast routing is a special satellite addressing and routing method, where each satellite does not need to communicate frequently with an address allocation server. During broadcasting of the address allocation signal, each satellite can independently complete the satellite addressing and establishment of the routing table.

The present disclosure has the following beneficial effect.
(1) A brand-new global address allocation system is provided, where a used address is closely integrated with a space. Key fields of the packet are more flexible. The brand-new packet communication protocol of the present disclosure is more flexible in setting the structure of each field, which can be dynamically adjusted according to the actual network size and the address requirements.
(2) The deployment position of the controller is taken into account. The deployment position of the controller is determined by using the node betweenness centrality, which ensures the short-distance communication between the controller and satellites.
(3) The distributed performance is better. The frequent communication between satellites can be greatly reduced and the address allocation speed is improved by using two types of packets to complete distributed address allocation.
(4) A routing table synchronous establishment mechanism is provided. The routing table establishment process is synchronized with the address allocation, which shortens the time of network address configuration and route configuration, thereby improving network efficiency. At the same time, it need not carry out re-routing calculation of the network in the later packet transmission.
(5) A preset and simplified routing table is provided. In the initial stage of address allocation, the backup path is preset, and a routing table is established by size value matching, which simplifies routing table entries and routing table structure to the greatest extent.

Advantages of additional aspects of the present disclosure will be set forth in the description which follows, or may be learned by practice of the present disclosure.

### BRIEF DESCRIPTION OF THE DRAWINGS

In order to explain the technical scheme in the embodiment of the present disclosure more clearly, the drawings that need to be used in the description of the embodiment will be briefly introduced hereinafter. Obviously, the drawings in the following description are only some embodiments of the present disclosure. For those skilled in the art, other drawings can be obtained according to these drawings without creative labor.

FIG. 1 is a flow chart of a distributed addressing and fast routing method according to an embodiment of the present disclosure.

FIG. 2 is a flow chart of establishing a satellite relative motion model according to an embodiment of the present disclosure.

FIG. 3 is a schematic diagram of a satellite orbit according to the embodiment of the present disclosure.

FIG. 4 is a schematic diagram of mirroring a satellite orbit according to an embodiment of the present disclosure.

FIG. 5 is a schematic diagram of a process of forming an equivalent matrix satellite topology according to an embodiment of the present disclosure.

FIG. 6 is a schematic diagram of an established relative motion model according to an embodiment of the present disclosure.

FIG. 7 is an example diagram of a relative motion model according to an embodiment of the present disclosure.

FIG. 8 is a flow chart of satellite address allocation according to an embodiment of the present disclosure.

FIG. 9 is a schematic diagram of a basic structure of a packet according to an embodiment of the present disclosure.

FIG. 10 is a schematic diagram of broadcasting an address allocation packet by a controller according to an embodiment of the present disclosure.

FIG. 11 is a schematic flow chart of processing the received packet by a satellite according to an embodiment of the present disclosure.

### DETAILED DESCRIPTION OF THE EMBODIMENTS

Hereinafter, embodiments of the present disclosure will be described in detail, examples of which are illustrated in the accompanying drawings, wherein the same or similar reference numerals indicate the same or similar elements or elements having the same or similar functions throughout. The embodiments described below through the attached drawings are exemplary, which are only used for explaining the present disclosure but cannot be interpreted as limiting the present disclosure.

It can be understood by those skilled in the art that unless otherwise defined, all terms (including technical terms and scientific terms) used herein have the same meaning as commonly understood by those skilled in the art to which the present disclosure belongs.

It should also be understood that terms such as those defined in general dictionaries should be understood to have meanings the same as those in the context of the prior art, and will not be interpreted in an idealized or overly formal sense unless defined as such.

It can be understood by those skilled in the art that the singular forms “a”, “an”, “said” and “the” used herein can also include plural forms unless specifically stated. It should be further understood that the word “including” used in the specification of the present disclosure refers to the presence of the features, integers, steps, operations, elements and/or components, but does not exclude the presence or addition of one or more other features, integers, steps, operations, elements and/or groups thereof.

In the description of this specification, descriptions referring to the terms “one embodiment”, “some embodiments”, “examples”, “specific examples” or “some examples” mean that specific features, structures, materials or characteristics described in connection with the embodiment or example are included in at least one embodiment or example of the present disclosure. Moreover, the specific features, structures, materials or characteristics described may be combined in any one or more embodiments or examples in a suitable manner. In addition, those skilled in the art can combine different embodiments or examples and features of different embodiments or examples described in this specification without contradicting each other.

In order to facilitate the understanding of the present disclosure, the present disclosure will be further explained with specific examples in conjunction with the attached drawings, and the specific examples do not constitute the limitations of the embodiments of the present disclosure.

It should be understood by those skilled in the art that the attached drawings are only schematic diagrams of embodiments, and the components in the attached drawings are not necessarily necessary for implementing the present disclosure.

### Embodiment 1

In Embodiment 1, a system of distributed addressing and fast routing is provided, including: an establishing module, a deploying module, an allocating module and a synchronizing module.

The establishing module is configured to allocate an orbit number, allocate a satellite number in an orbit, mirror a satellite orbit, form an equivalent matrix satellite topology, and establish a satellite relative motion model.

The deploying module is configured to select an appropriate reference frame satellite to deploy a controller based on an established satellite relative motion model, so that the communication time between the controller and a farthest satellite is the shortest when satellite addresses are allocated.

The allocating module is configured to complete a satellite address allocation based on a deployed controller.

The synchronizing module is configured to synchronously establish a routing table after confirming an address of a satellite itself and neighbor information based on an allocated satellite address.

In Embodiment 1, a distributed addressing and fast routing method is implemented by the above-mentioned system, including: allocating an orbit number to an orbit, allocating a satellite number to a satellite in the orbit, mirroring a satellite orbit, forming an equivalent matrix satellite topology, and establishing a satellite relative motion model by the establishing module; selecting, by the deploying module an appropriate reference frame satellite to deploy a controller based on the established satellite relative motion model, so that the communication time between the controller and the farthest satellite is the shortest upon allocating a satellite address; broadcasting, by the deploying module, an address allocation packet based on the deployed controller; receiving, by a satellite, a broadcasted address allocation packet and confirm an address of the satellite itself; and broadcasting, by the satellite, the address allocation packet to complete a satellite address allocation; finally, synchronously establishing, by the synchronizing module, a routing table after confirming the address of the satellite itself and neighbor information based on an allocated satellite address.

The allocating an orbit number includes: describing each orbit through a set O, where n is the total number of orbits in a low earth orbit satellite network, and sequentially numbering the orbits from a certain orbit;

O={O₁, O₂, O₃, . . . , Oₙ}.

The mirroring a satellite orbit includes: splitting an orbit of the satellite in an annular shape with an orbital intersection point as a split point; mirroring two split satellite orbits by the split point, so that the satellite orbits are in the same range at the same time; stretching a mirrored new orbit to stretch each orbit into a straight line, thereby forming a planar satellite motion topology.

The forming an equivalent matrix satellite topology includes: adjusting the planar satellite motion topology by using a satellite communication ability between adjacent orbits, and placing communicationable satellites with different orbits at the same horizontal position to form a satellite topology in matrix form.

Determining the relative motion model finally by the equivalent matrix satellite topology, includes: by selecting a moving satellites as a reference frame, establishing the relative motion model with a relative position as the satellite coordinates, a reference frame satellite as an origin, an orbit change direction of the reference frame satellite as x axis and an orbit of the reference frame satellite as y axis, and with motion position of each satellite expressed in form of coordinates.

A satellite where betweenness center point is located is selected as the reference frame satellite, and by means of the concept of betweenness centrality, a betweenness of a satellite node is the number of shortest paths passing through the satellite node in the network, and the betweenness centrality of the node is the sum of the ratio of the number of shortest paths between any two points passing through the node to the number of all shortest paths:

$$g ( v ) = {\sum }_{s \neq v \neq t} \frac{{σ}_{s t} ( v )}{{σ}_{s t}}$$

where σₛₜ is the total number of shortest paths from node s to node t, σₛₜ(v) is the number of paths passing through node v; a node with the largest betweenness centrality value is selected as the origin of the reference frame by comparing the betweenness centrality of each node, and the controller is deployed to realize the shortest path, that is, a betweenness center point v has the largest betweenness centrality, has the most shortest paths passing through the node, and paths from both ends of these shortest paths to the node v, i.e., a betweenness point v, are also the shortest paths, and the node v reaches the most other nodes in the shortest distance.

The address allocation packet structure includes: using layer 2 and layer 3 protocols of the network; where the layer 2 protocol is a standard Ethernet protocol, source/destination physical addresses are both satellite physical addresses in packet transmission; and the layer 3 protocol includes an address confirmation packet and an address update packet.

Both the address confirmation packet and the address update packet have the same source address length field and the same source address field; the address confirmation packet has a destination address field indicating a satellite address of a packet receiving end, and a receiving satellite confirms its own address according to this field; the destination address field that the address update packet has is variable in length, which stores an address space that the receiving satellite uses as its own address.

Broadcasting an address allocation packet based on the deployed controller; receiving, by the satellite, the broadcasted address allocation packet and confirming the address of the satellite itself; and broadcasting, by the satellite, the address allocation packet to complete the satellite address allocation, includes step S1-step S4.
Step S1: upon receiving the address confirmation packet, it is determined whether the packet is valid by the satellite; where a criteria of validity is whether a port has received such packet; if the packet is invalid, the packet is directly discarded; if the packet is valid, the packet is the first address confirmation packet received by the port.
Step S2: according to the first address confirmation packet received, the address of the satellite itself is determined, a source address, i.e. a sending satellite address, is stored, and a neighbor information of the satellite itself is recorded. In an application scenario, as the address confirmation packet contains the source address and the destination address, after satellite A receives the address confirmation packet from satellite B, the satellite A uses the destination address as its own address and stores the source address as the address of its neighbor satellite, i.e., the satellite B.
Step S3: the address update packet is broadcasted to a port that has not been invalidated by the satellite according to the address of the satellite itself and obtained neighbor information.

Step S4: the updated packet is broadcasted through the port by the satellite to update an available address space of surrounding satellites.

After the satellite receives the address update packet, the validity of the received address update packet is determined, where the validity is determined by whether the address confirmation packet has been received; if the satellite has received the address confirmation packet, the satellite has completed the address allocation, and newly received address update packet is directly discarded; conversely, if the address update packet is valid, the satellite extracts a plurality of available satellite addresses contained in a destination address of the address update packet and stores the available satellite addresses in a temporary register.

When the satellite receives the second address update packet, if the second address update packet is from the same source as the first packet, the satellite needs to extract a destination address content of the new packet and update the available satellite address space in the temporary register; if the second address update packet comes from a new satellite, the satellite extracts the destination address content of the new packet, compares a new address space with an old address space in the temporary register, and selects an overlapping address as the address of the satellite itself.

Comparing the new address space with the old address space in the temporary register includes: assuming that the old address space includes a set ADDR₁ and the new address space includes a set ADDR₂, selecting, by the satellite, an address addr_{final} of the satellite itself by comparing same elements in the two sets, as shown in following equation:

$${addr}_{final} = \{ addr \vert addr ∈ {ADDR}_{1} , a d dr ∈ {ADDR}_{2} \} .$$

In process of address allocation, the addr calculated by each satellite is unique; after confirming the address of the satellite itself, the satellite (e.g., satellite A) needs to store the neighbor information and reply the address confirmation packet to a source satellite (e.g., satellite B) that has sent the address update packet, to inform the source satellite (i.e., the satellite B) of satellite address of the satellite itself (i.e., the satellite address of the satellite A).

Broadcasting the address update packet to the port that has not been invalidated includes: using the address of the satellite itself as the source address, adding one to address coordinate of the satellite itself and/or subtracting one from the address coordinate of the satellite itself to form four addresses as the destination addresses, and removing a confirmed neighbor address from the destination addresses.

Synchronously establishing a routing table after confirming the address of the satellite itself and neighbor information based on the allocated satellite address includes: matching the routing table by using address coordinate magnitude, where header of the routing table includes condition 1 and condition 2 corresponding to matching conditions of the address coordinate magnitude, a next-hop address corresponding to next-hop forwarding satellite information of the packet, an exit port corresponding to a forwarding direction of the packet, and a priority indicating a priority order of each port when there are a plurality of exit ports. The routing table of a satellite with coordinate (u,v) contains four possible table lookup matching conditions, corresponding to four different directions of the destination address subsequent to the satellite; when one of the table lookup conditions is satisfied, the satellite preferentially selects a vertical direction to forward the packet; where the exit port corresponding to the next-hop address is filled in when a neighbor satellite information is acquired. The priority ensuring adjustment and backup of satellite forwarding path includes: changing, by the satellite, a packet forwarding direction by adjusting priority value; selecting, by the satellite, a backup path according to the priority value, when a link fails, to prevent a control information packet from failing to reach a destination satellite.

### Embodiment 2

In Embodiment 2, a distributed addressing and fast routing method is proposed. By establishing the relative motion model, according to the motion characteristics of polar orbit satellites, the motion amplitude of satellites in the topology is reduced, and the connection topology diagram between satellites is stabilized. Thereafter, based on the betweenness centrality, the deployment position of the controller is selected with a goal of shortening the communication distance. Finally, the routing table and the satellite address structure are deeply bound, and a brand-new satellite address scheme and the corresponding routing table structure are designed.

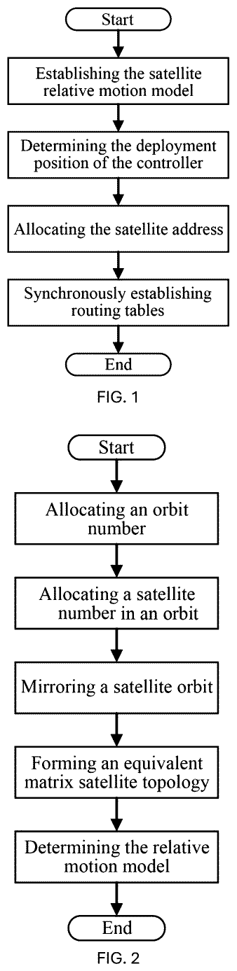

The overall flow chart of the method described in Embodiment 2 is shown in FIG. 1. The method mainly includes four modules, that is: establishing the satellite relative motion model, determining the deployment position of the controller, allocating the satellite address, and synchronously establishing routing tables. Through the above four main modules, distributed addressing and fast routing are completed in the polar orbit satellite control network, which provides basic guarantee for later data transmission.

When establishing the satellite relative motion model, it is necessary to distinguish each satellite for convenience of further use in subsequent modules. In addition, the design of the subsequent modules is based on the satellite relative motion model generated by the module configured to establish the satellite relative motion model. Therefore, the model configured to establish the satellite relative motion model is interpreted as an independent module. The specific establishing process of the module configured to establish the satellite relative motion model shown in FIG. 2, includes following parts: allocating an orbit number, allocating a satellite number to a satellite in an orbit, mirroring a satellite orbit, forming an equivalent matrix satellite topology, and determining the relative motion model.

Allocating the orbit number is mainly to describe the actual satellite orbit in a mathematical language. A polar orbit satellite network often has a plurality of satellite orbits parallel to the meridian generally and passing over the Arctic and Antarctic regions. Each orbit surrounds the earth and divides the surface of the earth equally, so as to ensure that satellite communication can be carried out in any area on the ground.

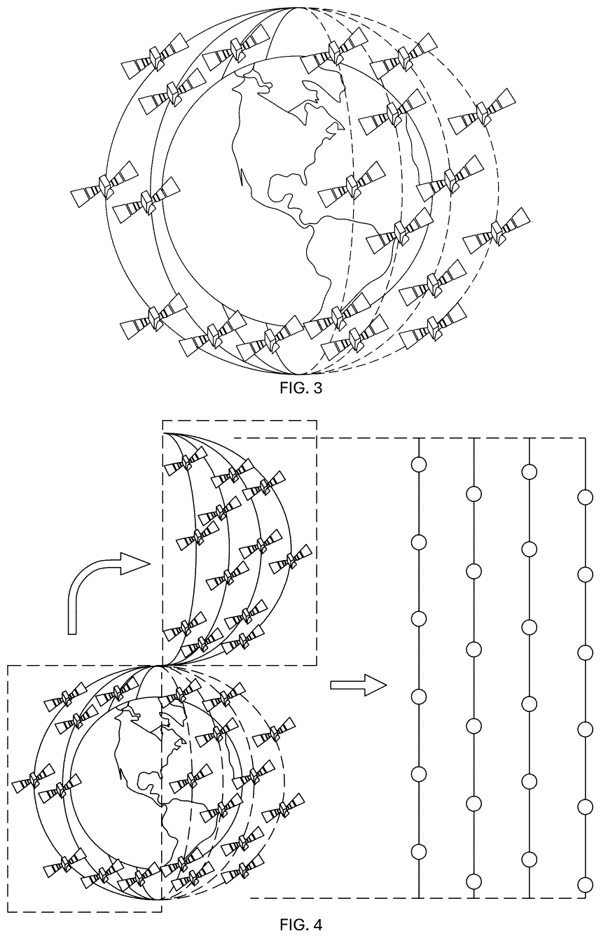

FIG. 3 is a schematic diagram of the satellite orbits including four polar orbits. In the actual polar orbit satellite network, the number of orbits is not only four, and various orbits are described by a set O, as shown in equation 1. n is the total number of orbits in a low earth orbit satellite network, and the orbits are sequentially numbered from west to east starting from a certain orbit:

$$O = \{ {O}_{1} , {O}_{2} , {O}_{3} , … , {O}_{n} \} . \qquad ( 1 )$$

Allocating the satellite number to a satellite in the orbit is to be described based on the above satellite orbits for a plurality of satellites in orbits, in the mathematical language. In the polar orbit satellite network, the ground area covered by a single satellite is limited. In order to ensure an extensive signal communication support, there are generally a plurality of satellites in each orbit at the same time. These satellites move in the same direction in one orbit and are evenly distributed on the orbital ring.

In addition, the orbit with a plurality of satellites is also stable to some extent, which can provide uninterrupted network service when a certain satellite fails. Considering that the number of satellites in each orbit is the same in the actual polar orbit satellite network, the number of satellites in each orbit is set as N₀ in this embodiment. The numbers of these orbit satellites can form a set N, as shown in equation 2, where N_{O}_{ᵢ} indicates the number of satellites in orbit Oᵢ. For satellites in each orbit, the satellites are numbered in sequence from south to north starting from a certain satellite.

$$N = \{ {N}_{{O}_{1}} , {N}_{{O}_{2}} , {N}_{{O}_{3}} , … , {N}_{{O}_{n}} \} = \{ {N}_{0} , {N}_{0} , {N}_{0} , … , {N}_{0} \} \qquad ( 2 )$$

Mirroring the satellite orbit is to adjust the satellite orbit to form a planar satellite motion topology. As shown in FIG. 3, the satellite orbit is a ring around the earth. Such motion mode requires three parameters to accurately indicate the satellite position. However, considering the same motion altitude of each satellite, the altitude parameter does not affect the satellite position.

Therefore, in this embodiment, the orbit of the satellite in an annular shape is split, mirrored and stretched, as shown in FIG. 4. By using the juncture above the North Pole and South Pole as the split points, the satellite orbit of the Western Hemisphere is mirrored with respect to the North Pole, so that the satellite orbits are in the Eastern Hemisphere at the same time. Then, the new orbits are stretched, and each orbit is stretched into a straight line, thereby forming a planar satellite motion topology with each satellite represented by a circle,.

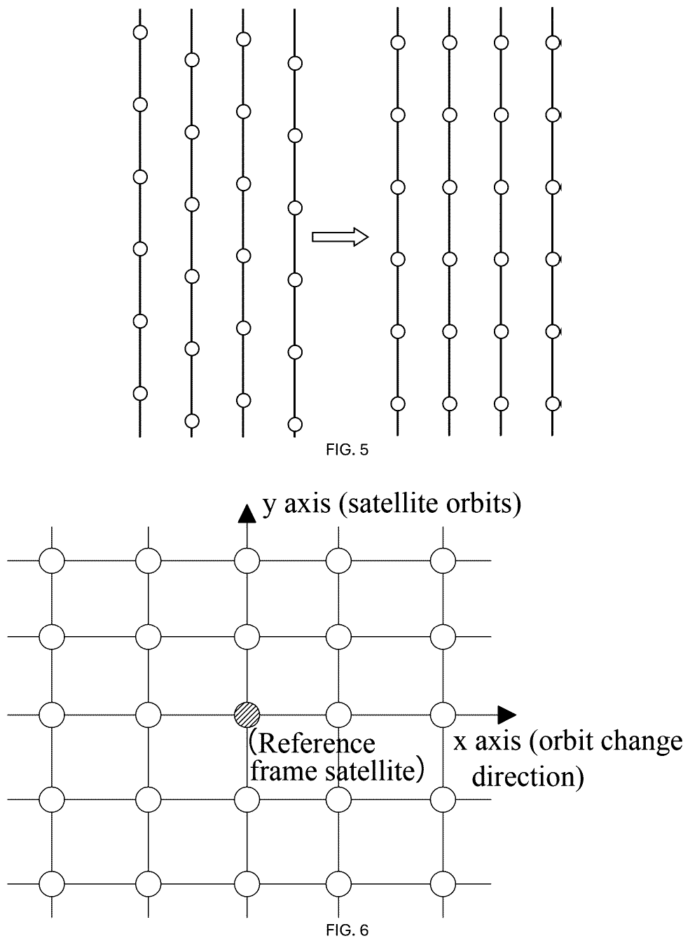

Forming the equivalent matrix satellite topology is to adjust the planar satellite motion topology further to form the equivalent matrix topology. In order to prevent the satellites from colliding at the juncture above the pole, satellites in each orbit has been set different operating time to ensure that the satellites pass through the pole in sequence. Therefore, in this case, the planar orbit topology of the satellite presents the characteristics of the same vertical position and different horizontal positions. In this embodiment, it is necessary to adjust the planar motion topology further by using the satellite communication capability between adjacent orbits, as shown in FIG. 5. The communicationable satellites in different orbits are placed at the same horizontal position to form a satellite topology in matrix form.

Determining the relative motion model is to determine the relative motion model finally by the equivalent matrix satellite topology. In this embodiment, based on the motion characteristics of satellites, the communication between satellites is designed, so it is necessary to discriminate and process the motion characteristics of satellites. In the actual polar orbit satellite network, the satellite keeps periodic motion with a high motion speed and short period. However, a relatively stable network topology is required to facilitate the research on satellites. Therefore, in this embodiment, the additional topological complexity resulted from the periodic motion is reduced to the most extent through selecting a moving satellite as the reference frame, and a relative position as the satellite coordinates. The reference frame satellite are used as the origin, the orbit change direction of the reference frame satellite is x axis, the orbit of the reference frame satellite is y axis, and the motion position of each satellite is expressed in the form of coordinates, as shown in FIG. 6. Based on this coordinates, the relative motion model is established.

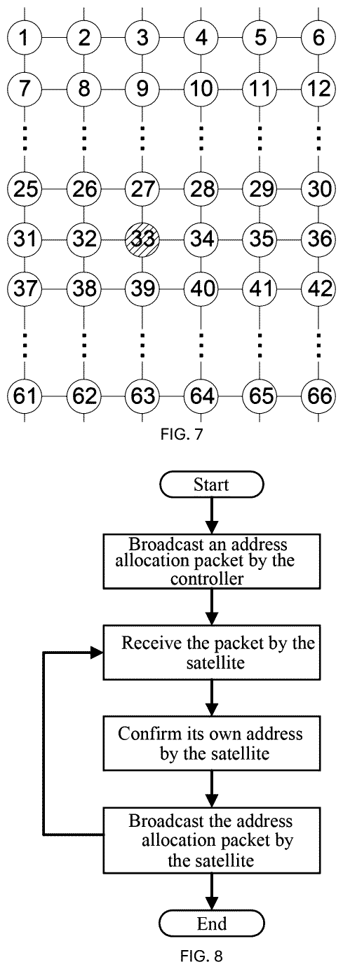

In this embodiment, when determining the deployment position of the controller, it is necessary to select an appropriate reference frame satellite and deploy the controller on the satellite, so that the communication time between the controller and the farthest satellite can be minimized when allocating satellite addresses. FIG. 7 shows a relative motion model of a polar orbit satellite network. The model includes 6 orbits and 11 satellites in each orbit and, in some embodiment, consists of 6 orbits and 11 satellites in each orbit. It can be found from the node connection lines in FIG. 7 that the connections between satellites in the same orbit are annular, that is, satellites 1, 7, 13, 19, 25, 31, 37, 43, 49, 55 and 61 are connected with each other in sequence. At the same time, the satellites 1 and 61 are also connected. Satellites in different orbits are connected in a straight line, that is, the satellites 1, 2, 3, 4, 5 and 6 are connected in sequence, while satellites 1 and 6 cannot be connected because, in the actual orbit, the west side of the orbit where the satellite 1 is located is the orbit where the satellite 6 is located but the satellites in the two orbits move in opposite directions, so that it is difficult to maintain long-term communication. In the model, in this embodiment, the satellite where the betweenness center point is located is selected as the reference frame satellite, that is, the satellite 33 in FIG. 7.

Considering requirements of the controller deployed in the network center in the later stage and a shorter distance between the controller and each satellite, the concept of betweenness centrality is borrowed in this embodiment. The betweenness centrality is a measure of graph centrality based on the shortest path. The betweenness of a node is the number of shortest paths passing through the node in a network. The betweenness centrality of the node is the sum of the ratios of the number of shortest paths between any two points passing through the node to the number of all shortest paths, which is expressed in equation 3.

$$g ( v ) = {\sum }_{s \neq v \neq t} \frac{{σ}_{s t} ( v )}{{σ}_{s t}} \qquad ( 3 )$$

where σₛₜ is the total number of shortest paths from node s to node t, σₛₜ(v) is the number of paths passing through node v. By comparing the betweenness centrality of each node, the node with the largest betweenness centrality value is selected as the origin of the reference frame, and the controller is deployed to realize the shortest path to the most extent. That is, the betweenness center point v has the largest betweenness centrality, and the most shortest paths pass through the node v (i.e., the betweenness center point v), the paths from both ends of these shortest paths to the node v are also the shortest paths, and the node v reaches the most other nodes in the shortest distance.

In this embodiment, when allocating satellite addresses, the distributed address allocation mechanism is used, and each satellite can complete its own address allocation without frequent communication with the central controller. The flow chart of the allocation process shown in FIG. 8, includes four main parts: broadcasting an address allocation packet by the controller, the satellite receiving the packet by the satellite, confirming its own address by the satellite, and broadcasting the address allocation packet by the satellite.

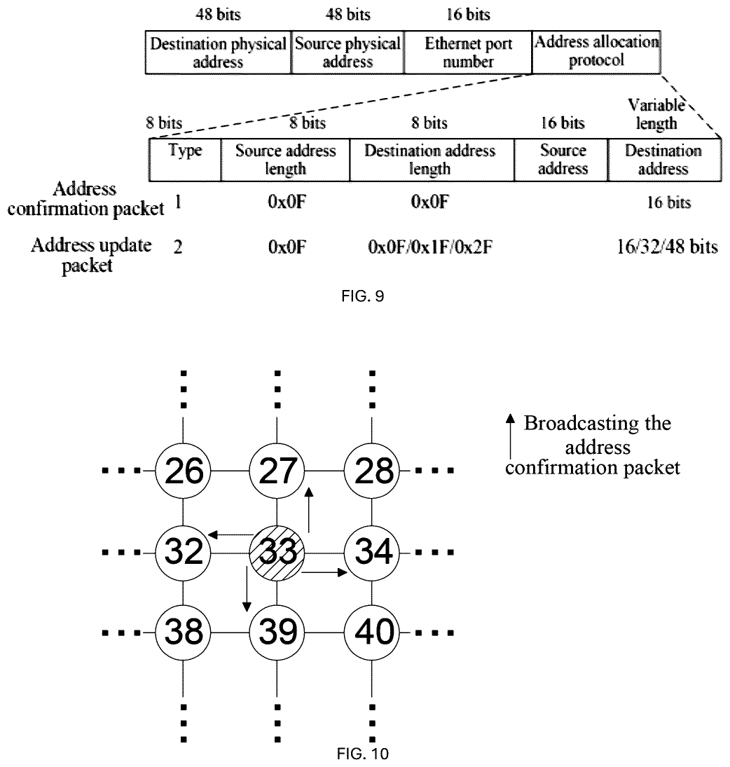

The basic structure of the packet, as a basis of satellite address allocation, shows the main structure of the communication packet in the process of address allocation. FIG. 9 shows the basic structure of the packet used in this embodiment. The packets in this embodiment mainly use the layer 2 and layer 3 protocols of the network. The layer 2 protocol is a standard Ethernet protocol, the source/destination physical addresses are all satellite physical addresses in packet transmission, and the Ethernet port number is the exclusive port number of the protocol used in this embodiment. The layer 3 protocol is a brand-new address allocation protocol, which uses a customized structure to complete the communication between satellites. where the type field is 8 bits, including two different packets. The first packet is an address confirmation packet, and the second packet is an address update packet. Both the address confirmation packet and the address update packet have the same source address length field and the same source address field. The two fields represent the information of the satellite at a packet sending end, and the satellite will only send out the packet after confirming its own address. The difference is that the address confirmation packet has a 16-bit destination address field indicating the satellite address of a packet receiving end. The receiving satellite confirms its own address according to this field. The destination address field in the address update packet is variable in length, which is 16 or 32 or 48 bits. This field stores the address space that the receiving satellite can use as its own address.

Broadcasts the address allocation packet by the controller is the beginning of the satellite address allocation process. The address allocation method designed in this embodiment needs to be triggered by a controller satellite to start the whole allocation process. FIG. 10 shows the broadcast process of the controller satellite. The controller satellite sets the address allocation protocol type as “1”, the source address length as “0x0F”, the destination address length as “0x0F”, the source address as “0,0” and the destination addresses as “0,−1”, “0,1”, “1,0” and “−1,0”. The four destination addresses represent the addresses of four neighboring satellites connected to the controller satellite, respectively. “0,−1” and “0,1” indicate that it needs to be sent in opposite directions, and “1,0” and “−1,0” indicate that it needs to be sent in opposite directions, too. The controller, after broadcasting this packet, waits for a completion of the entire network address allocation.

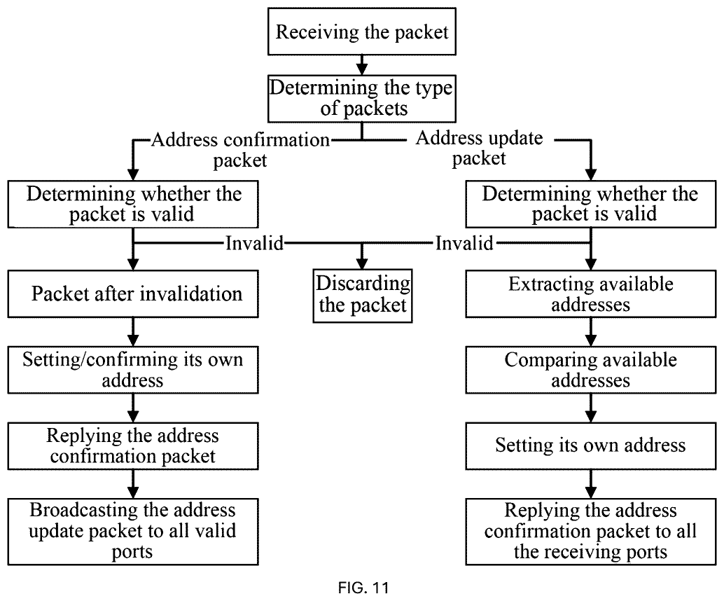

Receiving the packet by the satellite, confirming the address of the satellite itself, and broadcasting the address allocation packet are keys of satellite address allocation, mainly including the processing process of each satellite after receiving packets. FIG. 11 is a complete flow chart of a satellite processing the packet. For the address confirmation packet and the address update packet, the satellite has different processing methods.
(1) Processing the address confirmation packet: the address confirmation packet is used to allocate an address to the destination satellite. For each port of each satellite, the packet only needs to be received once to confirm its own address. Receiving and processing this type of packets for many times will increase the unnecessary operation burden of satellites, which affects the rapid transmission of packets. Therefore, after receiving this type of packets, the satellite needs to determine whether the packet is valid based on whether the port has received such packet. If the packet is invalid, the packet is directly discarded. If the packet is valid, it means that the packet is the first such packet received by the port. The satellite needs to denote packets received by the port later as invalid to prevent receiving useless packets repeatedly. For the valid packet, the satellite extracts the destination address field therein, set the content therein as the address of the satellite itself, and stores the content in the satellite register. At the same time, the satellite stores the source address, i.e. the sending satellite address, and records the neighbor information of the satellite itself. Thereafter, the satellite needs to reply the address confirmation packet to the receiving port in order to inform the sending end a receipt of the packet and a completion of the address allocation. After that, the satellite needs to broadcast an address update packet to the port that has not been invalidated according to the address of the satellite itself and the obtained neighbor information. In the packet, the address of the satellite itself is set as the source address, the destination addresses is obtained by adding one to the address coordinate of the satellite itself and subtracting one from the address coordinate of the satellite itself to form four addresses and removing the confirmed neighbor address from the destination address at the same time. The satellite broadcasts the packet through the port to update the available address space of the surrounding satellites. For example, the address coordinates of the satellite itself are (x, y), the formed four destination addresses are (x+1, y+1), (x−1, y−1), (x+1, y−1) and (x−1, y+1).
(2) Processing the address update packet: the address update packet is used to send the available address space to the destination satellite. Such packet is generated because some satellites can not receive the address confirmation packet. Like the satellite 26 in FIG. 10, after the address confirmation packet is broadcast by the controller satellite 33, the satellites 27 and 32 can confirm their own addresses and reply the confirmation information to the controller satellite. If there is no address update packet, the satellite 26 will never receive the address confirmation or update information, resulting in a stagnation of the address allocation process. Therefore, such packets are needed to help the satellite 26 confirm its address. After the satellite receives the address update packet, the validity of the received address update packet also needs to be determined based on whether the address confirmation packet has been received. If the satellite has received the address confirmation packet, it means that the satellite has completed the address allocation, and the newly received address update packet is useless and can be directly discarded. On the contrary, if the address confirmation packet is valid, the satellite extracts a plurality of available satellite addresses contained in the destination address of the address confirmation packet and stores the available satellite addresses in a temporary register. At this point, the processing of the satellite is suspended. When the satellite receives the second address update packet, there are two possibilities. (1) the packet is from the same source as the first packet. In this case, the satellite needs to extract the destination address content of the new packet and update the available satellite address space in the temporary register. (2) the second address update packet comes from a new satellite. In this case, the satellite also needs to extract the destination address content of the new packet, but the difference is that the satellite compares the new address space with the old address space in the temporary register, and selects the overlapping address as the address of the satellite itself. It is assumed that the old address space is a set ADDR₁ and the new address space is a set ADDR₂. The satellite selects its own address addr_{final} by comparing the same elements in the two sets, as shown in equation 4.

$${addr}_{final} = \{ addr \vert addr ∈ {ADDR}_{1} , addr ∈ {ADDR}_{2} \} \qquad ( 4 )$$

It is worth noting that in the process of address allocation, the addr calculated by each satellite is unique, and a situation that a plurality of addresses corresponds to one satellite does not occur. After confirming the address of the satellite itself, the satellite needs to store the neighbor information and reply the address confirmation packet to the source satellite that has sent the address update packet to inform the source satellite the address of the satellite itself. The whole motion process is automatically operated by the satellite. Except for the trigger of the controller satellite in the initial stage, all satellites can automatically complete the address allocation at the rest of the time, and will automatically end the process after the address allocation is completed,.

In this embodiment, when the routing table is established synchronously, there is a unique design for the routing table of the packets between satellites. In the process of satellite address allocation, the routing table can be established synchronously without secondary communication with other satellites. After confirming the address of the satellite itself and neighbor information, the satellite can start to establish the routing table synchronously.

The routing table used in this embodiment is different from the traditional IP network routing table, which does no longer use the longest prefix matching, but uses the address coordinate magnitude matching. The basic structure of the header of the routing table in this embodiment is shown in Table 1. The routing table contains five basic headers, the condition 1 and condition 2 corresponding to the address coordinate magnitude matching conditions, a next-hop address corresponding to next-hop forwarding satellite information of the packet, an exit port corresponding to a forwarding direction of the packet, and the priority indicating a priority order of each port when there are a plurality of exit ports.

TABLE 1

| | | | | |
|---|---|---|---|---|
| condition 1 | condition 2 | next-hop address | exit port | priority |

Table 2 shows details of the routing table of the satellite with coordinate (u,v). Table 2 contains four possibilities of main table lookup matching conditions, which correspond to four different directions of the destination address subsequent to this satellite. When one of the table lookup conditions is satisfied, the satellite preferentially selects the vertical direction to forward the packet because the satellite connection in the vertical direction is more stable, thereby transmitting the packet to the vicinity of the destination satellite as soon as possible. The exit port corresponding to the next-hop address, is filled in when acquiring the neighbor satellite information.

The priority brings possibility of adjustment and sufficient backup paths for satellite forwarding. First, the satellite may change the packet forwarding direction by adjusting the priority value, so as to meet the new network requirements. In addition, when a link fails, the satellite may select a backup path according to the priority value to prevent the control information packet from failing to reach the destination satellite.

This method of storing the backup path in advance when the address is allocated has great advantages in time compared with the mechanism of finding a new path after failure occurs. This synchronization method can minimize the time for establishing the routing table, and at the same time, it can still ensure the uninterrupted data transmission service after failure occurs.

TABLE 2

| | | next-hop | exit | |
|---|---|---|---|---|
| Condition 1 | Condition 2 | address | port | priority |
| & ≥ u | v ≤ & ≤ v + N₀/2 | (u, v + 1) | 2 | 1 |
| | or | (u + 1, v) | 1 | 2 |
| | & ≤ v − N₀/2 | | | |
| & ≥ u | v − N₀/2 < & < v | (u, v − 1) | 4 | 1 |
| | or | (u + 1, v) | 1 | 2 |
| | & > v + N₀/2 | | | |
| & < u | v ≤ & ≤ v + N₀/2 | (u, v + 1) | 2 | 1 |
| | or | (u − 1, v) | 3 | 2 |
| | & ≤ v − N₀/2 | | | |
| & < u | v − N₀/2 < & < v | (u, v − 1) | 4 | 1 |
| | or | (u − 1, v) | 3 | 2 |
| | & > v + N₀/2 | | | |

So far, the complete process of allocating the distributed satellite address and synchronously establishing the routing table in this embodiment has been introduced. A complete satellite network configuration method and system are completed by putting forward the relative motion model, selecting the betweenness center point, deploying the controller, allocating the distributed address and synchronously establishing the routing table. The system has great advantages in many aspects.

To sum up, the key point in Embodiment 2 is to design a distributed addressing and fast routing method used in mobile Ad Hoc networks (satellite networks) and a system thereof, and propose a relative motion model with the satellite itself as the reference frame. This model is different from the traditional satellite motion model with the ground as the reference frame. It is difficult for the model with the ground as the reference frame to form a stable network topology due to the high-speed movement of satellites, which has a negative impact on the researches, such as connection between satellites, satellite addressing and satellite routing. However, in the relative motion model, the relative motion between satellites is slow, and the topology formed by the connection of satellite networks is more stable. Thus this model can better show the motion relationship between satellites and help to carry out various studies on communication between satellites.

In this embodiment, a controller satellite selection method based on the betweenness center point is proposed. The betweenness center point is the intersection which the most shortest paths pass through. A shorter communication distance between the controller and the satellites can be ensured by deploying the controller on the satellite where the betweenness center point is located, thereby reducing the extra communication delay between the controller and the satellites during packet transmission.

In this embodiment, an addressing method with a satellite coordinate as the address is proposed. Based on the relative motion model and the betweenness center point, the network addressing of each satellite can be directly completed with the satellite relative coordinate as the satellite address. The addressing method reduces complex mapping between the satellite position and the satellite address, and reduces addressing cost. At the same time, the address has great advantages for communication between adjacent satellites. The address difference between adjacent satellites is one, which is easy to form a simple routing table and accelerates the packet routing table lookup speed.

In this embodiment, a brand-new address allocation protocol is proposed by using an idea of distributed address allocation. The protocol is triggered by the controller through two types of packets, so that each satellite can finish the address allocation reactively and independently. Each satellite does not need to communicate with the controller frequently, which reduces the cost of address allocation. At the same time, the present disclosure takes into account the problem of satellite communication resources, and filters the received packet and the packet to be sent by determining the validity of two types of packets, thus greatly reducing the transmission of useless packets between satellites.

In this embodiment, the routing table establishing process is integrated into the address allocation stage. This integrating method avoids the secondary communication consumption of determining the routing path among satellites after completing the address allocation, and shortens the satellite network configuration time and improves the configuration efficiency.

In this embodiment, a routing table magnitude matching method is proposed. Aiming at the proposed non-clustered coordinate address, the matching method extracts the key fields of the address and performs magnitude matching with the address range of the routing table to determine the routing direction of the packet. This matching idea has great advantages in non-clustered address routing and can provide a new direction for address matching.

In this embodiment, a multi-exit routing table framework is proposed. Compare with the traditional single-exit route matching mode, the present disclosure expand the route exit. In general, packets are routed by a first exit. When the path of the first exit fails, the routing table can automatically switch the exit, and use a second exit as the new routing direction to realize uninterrupted data transmission.

### Embodiment 3

Embodiment 3 provides a non-transient computer-readable storage medium, in which computer instructions are stored. The computer instructions, when executed by a processor, implement the distributed addressing and fast routing method as described above.

### Embodiment 4

Embodiment 4 provides a computer program product including a computer program, wherein the computer program, when operating on one or more processors, implements the distributed addressing and fast routing method as described above.

### Embodiment 5

Embodiment 5 provides an electronic device including a processor, a memory and a computer program, where the processor is connected with the memory, the computer program is stored in the memory, and when the electronic device operates, the processor executes the computer program stored in the memory, so that the electronic device executes instructions for implementing the distributed addressing and fast routing method as described above.

To sum up, the distributed addressing and fast routing method and a system thereof described in the embodiment of the present disclosure have the following characteristics.

First, the fixed structure of the original IPv4 address is broken, and a coordinate address based on the communication relationship between satellites is proposed. With a full use of the inter-satellite communication characteristics of polar orbit satellites, the satellite relative motion model is established with the satellites themselves as the reference frame to ensure a stable topological structure. On this basis, each satellite is allocated a unique coordinate address from a global perspective to facilitate data communication between satellites. This address is closely related to the space position of the satellite, which can ensure the most sufficiently use of space information.

Second, the processes of allocating the satellite address and establishing the satellite routing table are synchronized. The process of establishing the satellite routing table is advanced and synchronized with the process of allocating the satellite address. After the satellite receives the address allocation information, on the one hand, the satellite can confirm its own address according to the information, and on the other hand, the satellite can also acquire information of surrounding nodes from the address allocation information and establish the routing table synchronously. The idea of synchronous operation greatly reduces the frequent transmission of packets and accelerates the configuration speed of the satellite control network. In the process of address allocation, each satellite only needs to send no more than ten control packets at most, to complete the address allocation independently. The routing table information is filled during the address allocation process, that is, a piece of information in the routing table is filled upon obtaining the address of the satellite itself and the address of its neighbor satellite, which reduces the time for subsequent recalculation of routes.

Third, a brand-new routing table structure is proposed. Instead of using the longest prefix matching method, the key field size value matching mode is used. This mode makes full use of the characteristics of the coordinate satellite address, greatly simplifies the satellite routing table, and ensures sufficient shortest transmission paths at the same time. For any satellite, its routing table has at most four routing table entries, to complete a correct table lookup and forwarding of control signals. In addition, the four entries can also include all the shortest paths from the satellite to the destination satellite.

In a specific embodiment, the distributed addressing and fast routing method of the present disclosure can be used in future large-scale low earth orbit satellite networks (tens of thousands of low earth orbit satellites). By deploying one or more controllers and triggering the network-wide address allocation, each satellite can receive the packet independently, analyze the content, allocate the address and further spread packets. Even in a large-scale low earth orbit satellite network, the address allocation, the routing table configuration and the later routing table lookup can be completed in a relatively short time, and the network can be put into practical application quickly after deployment.

In another specific embodiment, the distributed addressing and fast routing method of the present disclosure can be applied to the network with non-high density connection. For a general terrestrial network, the present disclosure can also complete such an address allocation mechanism. The basis of the present disclosure is to arrange all forwarding nodes in a matrix, and the address allocation is completed at each node. In a general terrestrial network, the node topology with a matrix-like arrangement can be formed by abstracting the terrestrial network with satellites in the terrestrial network as nodes in the node topology, connection relationship between satellites in the terrestrial network as sides in the node topology. And then the node position is adjusted. The node topology can also be used in and conductive to address allocation and routing table configuration.

It should be understood by those skilled in the art that embodiments of the present disclosure can be provided as a method, a system, or a computer program product. Therefore, the present disclosure can take the form of an entirely hardware embodiment, an entirely software embodiment, or an embodiment combining software and hardware aspects. Furthermore, the present disclosure can take the form of a computer program product embodied on one or more computer-usable storage media (including but not limited to a disk storage, a CD-ROM, an optical storage, etc.) containing computer-usable program codes therein.

The present disclosure is described with reference to flow charts and/or block diagrams of the method, the device (system) and the computer program product according to an embodiment of the present disclosure. It should be understood that each flow and/or block in the flow chart and/or block diagram, and combinations of the flows and/or blocks in the flow chart and/or block diagram can be implemented by computer program instructions. These computer program instructions may be provided to a processor of a general-purpose computer, a special-purpose computer, an embedded processor or other programmable data processing devices to produce a machine, so that the instructions which are executed by the processor of the computer or other programmable data processing devices produce means for implementing the functions specified in one or more flows in the flow chart and/or one or more blocks in the block diagram.

These computer program instructions may also be stored in a computer-readable memory that can direct a computer or other programmable data processing devices to function in a particular manner, so that the instructions stored in the computer-readable memory produce an article of manufacture including instruction means. The instruction means implements the functions specified in one or more flows in the flow chart and/or one or more blocks in the block diagram.

These computer program instructions can also be loaded on a computer or other programmable data processing devices. A series of operation steps are performed on the computer or other programmable devices to produce computer-implemented processes, so that the instructions executed on the computer or other programmable devices provide steps for implementing the functions specified in one or more flows in the flow chart and/or one or more blocks in the block diagram.

Although the detailed description of the present disclosure has been described in conjunction with the attached drawings, it is not a limitation on the scope of protection of the present disclosure. It should be understood by those skilled in the art that various modifications or deformations that can be made by those skilled in the art without creative labor on the basis of the technical scheme provided in the present disclosure should be included in the scope of protection of the present disclosure.

1. A distributed addressing and fast routing method, comprising:
allocating an orbit number to an orbit, allocating a satellite number to a satellite in the orbit, mirroring the orbit of the satellite, forming an equivalent matrix satellite topology, and establishing a satellite relative motion model;
selecting a reference frame satellite to deploy a controller based on an established satellite relative motion model, so that communication time between the controller and a farthest satellite is shortest upon allocating a satellite address;
broadcasting an address allocation packet based on the controller deployed; receiving, by the satellite, the address allocation packet broadcasted, and confirming an address of the satellite itself, and broadcasting, by the satellite, the address allocation packet to complete a satellite address allocation;
synchronously establishing a routing table after confirming the address of the satellite itself and neighbor information based on an allocated satellite address.

2. The method according to claim 1, wherein the allocating an orbit number comprises: describing each orbit through a set O, where n is a total number of orbits in a low earth orbit satellite network, and sequentially numbering the orbits from a certain orbit;
O={O₁, O₂, O₃, . . . , Oₙ};
the mirroring the orbit of the satellite comprises: splitting the orbit of the satellite in an annular shape with an orbital intersection point as a split point; mirroring two split satellite orbits by the split point, so that the satellite orbits are in a same range; stretching mirrored orbits such that each orbit is stretched into a straight line, thereby forming a planar satellite motion topology;
the forming an equivalent matrix satellite topology comprises: adjusting the planar satellite motion topology by using a satellite communication ability between adjacent orbits, and placing communicationable satellites in different orbits at a same horizontal position to form a satellite topology in matrix form.

3. The method according to claim 2, wherein determining the relative motion model finally by the equivalent matrix satellite topology, comprises: by selecting a moving satellite as a reference frame, establishing the relative motion model with a relative position as satellite coordinates, a reference frame satellite as an origin, an orbit change direction of the reference frame satellite as x axis and an orbit of the reference frame satellite as y axis, and with motion position of each satellite expressed in form of coordinates, and;
selecting a satellite where a betweenness center point is located as the reference frame satellite, and by means of a concept of betweenness centrality, obtaining a betweenness of a satellite node as a number of shortest paths passing through the satellite node in the network, and betweenness centrality of the satellite node as a sum of ratios of a number of shortest paths between any two points passing through the satellite node to a number of all shortest paths:
$$g ( v ) = {\sum }_{s \neq v \neq t} \frac{{σ}_{s t} ( v )}{{σ}_{s t}}$$
where σₛₜ is a total number of shortest paths from node s to node t, σₛₜ(v) is a number of paths passing through node v; a node with a largest betweenness centrality value is selected as the origin of the reference frame by comparing the betweenness centrality of each node, and the controller is deployed to realize the shortest paths, that is, the betweenness center point v has a largest betweenness centrality, has a most number of shortest paths passing through the node, and paths from both ends of these shortest paths to a node v, i.e., the betweenness center point v, are also the shortest paths, and the node v reaches most other nodes in the shortest distance.

4. The method according to claim 1, wherein the address allocation packet in terms of structure comprises layer 2 and layer 3 protocols of the network; wherein the layer 2 protocol is a standard Ethernet protocol, source/destination physical addresses are both satellite physical addresses in packet transmission; and the layer 3 protocol contains an address confirmation packet and an address update packet;
both the address confirmation packet and the address update packet have a same source address length field and a same source address field; the address confirmation packet has a destination address field indicating a satellite address of a packet receiving end, a receiving satellite confirms its own address according to the destination address field; the destination address field in the address update packet is variable in length, which stores an address space that the receiving satellite uses as an address of the receiving satellite itself.

5. The method according to claim 4, wherein the broadcasting an address allocation packet based on the controller deployed; receiving, by the satellite, the address allocation packet broadcasted and confirming an address of the satellite itself, and broadcasting, by the satellite, the address allocation packet to complete a satellite address allocation, comprises:
upon receiving the address confirmation packet, determining, by the satellite, whether the address confirmation packet is valid, where a determination criteria of validity is whether a port has received the address confirmation packet; if the address confirmation packet is invalid, the address confirmation packet is directly discarded; if the address confirmation packet is valid, the address confirmation packet is a first address confirmation packet received by the port;
according to the first address confirmation packet received, determining the address of the satellite itself, storing a source address as a sending satellite address, and recording neighbor information of the satellite itself;
broadcasting, by the satellite, the address update packet to a port that has not been invalidated according to the address of the satellite itself and the neighbor information obtained;
broadcasting, by the satellite, the address update packet through the port to update an available address space of surrounding satellites.

6. The method according to claim 5, wherein after the satellite receives the address update packet, a validity of the address update packet received is determined the validity is determined by whether the address confirmation packet has been received; if the satellite has received the address confirmation packet, the satellite has completed address allocation, and newly received address update packet is directly discarded; conversely, if the address update packet is valid, the satellite extracts a plurality of available satellite addresses contained in destination addresses of the address update packet and stores the available satellite addresses in a temporary register.

7. The method according to claim 6, when the satellite receives a second address update packet, if the second address update packet is from a same source as a first address update packet, extracting, by the satellite, a destination address content of a new packet and updating an available satellite address space in the temporary register; if the second address update packet comes from a new satellite, extracting, by the satellite, the destination address content of the second address update packet, and comparing a new address space with an old address space in the temporary register, and selecting an overlapping address as the address of the satellite itself.

8. The method according to claim 7, the comparing a new address space with an old address space in the temporary register comprises: assuming that the old address space is a set ADDR₁ and the new address space is a set ADDR₂, selecting, by the satellite, an address addr_{final} of the satellite itself by comparing same elements in two sets, as shown in following equation:
$${addr}_{final} = \{ addr \vert addr ∈ {ADDR}_{1} , a d dr ∈ {ADDR}_{2} \} ;$$
wherein in process of the address allocation, addr calculated by each satellite is unique; upon confirming the address of the satellite itself, the satellite needs to store the neighbor information and reply the address confirmation packet to a source satellite that has sent the address update packet to inform the source satellite of the address of the satellite itself;
the broadcasting, by the satellite, the address update packet to a port that has not been invalidated comprises: using the address of the satellite itself as the source address, adding one to address coordinates of the satellite itself and subtracting one from the address coordinates of the satellite itself to form four addresses as the destination addresses, and removing a confirmed neighbor address from the destination addresses.

9. The method according to claim 1, the synchronously establishing a routing table after confirming the address of the satellite itself and neighbor information based on an allocated satellite address comprises: matching the routing table by using address coordinate magnitude, wherein header of the routing table comprises condition 1 and condition 2 corresponding a matching condition of the address coordinate magnitude, a next-hop address corresponding to next-hop forwarding satellite information of the packet, an exit port corresponding to a forwarding direction of the packet, and a priority indicating a priority order of each port when there are a plurality of exit ports;
wherein the routing table of a satellite with coordinates (u,v) contains four possible table lookup matching conditions corresponding to four different directions of the destination addresses for the satellite with coordinate (u,v); when one of the table lookup conditions is satisfied, the satellite with coordinate (u,v) preferentially selects a vertical direction to forward the packet; the exit port corresponding to the next-hop address and is filled in when neighbor satellite information is acquired;
the priority ensuring adjustment and backup of satellite forwarding path comprises: changing, by the satellite, a packet forwarding direction by adjusting priority value; when a link fails, selecting, by the satellite, a backup path according to the priority value to prevent a control information packet from failing to reach a destination satellite.

10. A system of distributed addressing and fast routing based on the method according to claim 1, comprising:
an establishing module, configured for allocating an orbit number to an orbit, allocating a satellite number to a satellite in an orbit, mirroring the orbit of the satellite, forming an equivalent matrix satellite topology, and establishing a satellite relative motion model;
a deploying module, configured for selecting an appropriate reference frame satellite to deploy a controller based on an established satellite relative motion model, so that communication time between the controller and a farthest satellite is the shortest upon allocating satellite addresses;
an allocating module, configured for completing a satellite address allocation based on a deployed controller;
a synchronizing module, configured for synchronously establishing a routing table after confirming an address of a satellite itself and neighbor information based on an allocated satellite address.

11. The system according to claim 10, wherein the allocating an orbit number comprises: describing each orbit through a set O, where n is a total number of orbits in a low earth orbit satellite network, and sequentially numbering the orbits from a certain orbit;
O={O₁, O₂, O₃, . . . , Oₙ};
the mirroring the orbit of the satellite comprises: splitting the orbit of the satellite in an annular shape with an orbital intersection point as a split point; mirroring two split satellite orbits by the split point, so that the satellite orbits are in a same range; stretching mirrored orbits such that each orbit is stretched into a straight line, thereby forming a planar satellite motion topology;
the forming an equivalent matrix satellite topology comprises: adjusting the planar satellite motion topology by using a satellite communication ability between adjacent orbits, and placing communicationable satellites in different orbits at a same horizontal position to form a satellite topology in matrix form.

12. The system according to claim 11, wherein determining the relative motion model finally by the equivalent matrix satellite topology, comprises: by selecting a moving satellite as a reference frame, establishing the relative motion model with a relative position as satellite coordinates, a reference frame satellite as an origin, an orbit change direction of the reference frame satellite as x axis and an orbit of the reference frame satellite as y axis, and with motion position of each satellite expressed in form of coordinates, and;
selecting a satellite where a betweenness center point is located as the reference frame satellite, and by means of a concept of betweenness centrality, obtaining a betweenness of a satellite node as a number of shortest paths passing through the satellite node in the network, and betweenness centrality of the satellite node as a sum of ratios of a number of shortest paths between any two points passing through the satellite node to a number of all shortest paths:
$$g ( v ) = {\sum }_{s \neq v \neq t} \frac{{σ}_{s t} ( v )}{{σ}_{s t}}$$
where σₛₜ is a total number of shortest paths from node s to node t, σₛₜ(v) is a number of paths passing through node v; a node with a largest betweenness centrality value is selected as the origin of the reference frame by comparing the betweenness centrality of each node, and the controller is deployed to realize the shortest paths, that is, the betweenness center point v has a largest betweenness centrality, has a most number of shortest paths passing through the node, and paths from both ends of these shortest paths to a node v, i.e., the betweenness center point v, are also the shortest paths, and the node v reaches most other nodes in the shortest distance.

13. The system according to claim 10, wherein the address allocation packet in terms of structure comprises layer 2 and layer 3 protocols of the network; wherein the layer 2 protocol is a standard Ethernet protocol, source/destination physical addresses are both satellite physical addresses in packet transmission; and the layer 3 protocol contains an address confirmation packet and an address update packet;
both the address confirmation packet and the address update packet have a same source address length field and a same source address field; the address confirmation packet has a destination address field indicating a satellite address of a packet receiving end, a receiving satellite confirms its own address according to the destination address field; the destination address field in the address update packet is variable in length, which stores an address space that the receiving satellite uses as an address of the receiving satellite itself.

14. The system according to claim 13, wherein the broadcasting an address allocation packet based on the controller deployed; receiving, by the satellite, the address allocation packet broadcasted and confirming an address of the satellite itself, and broadcasting, by the satellite, the address allocation packet to complete a satellite address allocation, comprises:
upon receiving the address confirmation packet, determining, by the satellite, whether the address confirmation packet is valid, where a determination criteria of validity is whether a port has received the address confirmation packet; if the address confirmation packet is invalid, the address confirmation packet is directly discarded; if the address confirmation packet is valid, the address confirmation packet is a first address confirmation packet received by the port;
according to the first address confirmation packet received, determining the address of the satellite itself, storing a source address as a sending satellite address, and recording neighbor information of the satellite itself;
broadcasting, by the satellite, the address update packet to a port that has not been invalidated according to the address of the satellite itself and the neighbor information obtained;
broadcasting, by the satellite, the address update packet through the port to update an available address space of surrounding satellites.

15. The system according to claim 14, wherein after the satellite receives the address update packet, a validity of the address update packet received is determined the validity is determined by whether the address confirmation packet has been received; if the satellite has received the address confirmation packet, the satellite has completed address allocation, and newly received address update packet is directly discarded; conversely, if the address update packet is valid, the satellite extracts a plurality of available satellite addresses contained in destination addresses of the address update packet and stores the available satellite addresses in a temporary register.

16. The system according to claim 15, when the satellite receives a second address update packet, if the second address update packet is from a same source as a first address update packet, extracting, by the satellite, a destination address content of a new packet and updating an available satellite address space in the temporary register; if the second address update packet comes from a new satellite, extracting, by the satellite, the destination address content of the second address update packet, and comparing a new address space with an old address space in the temporary register, and selecting an overlapping address as the address of the satellite itself.

17. The system according to claim 16, the comparing a new address space with an old address space in the temporary register comprises: assuming that the old address space is a set ADDR₁ and the new address space is a set ADDR₂, selecting, by the satellite, an address addr_{final} of the satellite itself by comparing same elements in two sets, as shown in following equation:
$${addr}_{final} = \{ addr \vert addr ∈ {ADDR}_{1} , a d dr ∈ {ADDR}_{2} \} ;$$
wherein in process of the address allocation, addr calculated by each satellite is unique; upon confirming the address of the satellite itself, the satellite needs to store the neighbor information and reply the address confirmation packet to a source satellite that has sent the address update packet to inform the source satellite of the address of the satellite itself;
the broadcasting, by the satellite, the address update packet to a port that has not been invalidated comprises: using the address of the satellite itself as the source address, adding one to address coordinates of the satellite itself and subtracting one from the address coordinates of the satellite itself to form four addresses as the destination addresses, and removing a confirmed neighbor address from the destination addresses.

18. The system according to claim 10, the synchronously establishing a routing table after confirming the address of the satellite itself and neighbor information based on an allocated satellite address comprises: matching the routing table by using address coordinate magnitude, wherein header of the routing table comprises condition 1 and condition 2 corresponding a matching condition of the address coordinate magnitude, a next-hop address corresponding to next-hop forwarding satellite information of the packet, an exit port corresponding to a forwarding direction of the packet, and a priority indicating a priority order of each port when there are a plurality of exit ports;
wherein the routing table of a satellite with coordinates (u,v) contains four possible table lookup matching conditions corresponding to four different directions of the destination addresses for the satellite with coordinate (u,v); when one of the table lookup conditions is satisfied, the satellite with coordinate (u,v) preferentially selects a vertical direction to forward the packet; the exit port corresponding to the next-hop address and is filled in when neighbor satellite information is acquired;
the priority ensuring adjustment and backup of satellite forwarding path comprises: changing, by the satellite, a packet forwarding direction by adjusting priority value; when a link fails, selecting, by the satellite, a backup path according to the priority value to prevent a control information packet from failing to reach a destination satellite.
